(19) United States
(12) Patent Application Publication
(10) Pub. No.: US 2023/0094984 A1
(43) Pub. Date: Mar. 30, 2023

(54) INFORMATION PROCESSING DEVICE, SYSTEM, METHOD, AND NON-TRANSITORY COMPUTER-READABLEMEDIUM STORING PROGRAM

(71) Applicant: NEC Corporation, Minato-ku, Tokyo (JP)

(72) Inventor: Takanori TANAKA, Tokyo (JP)

(73) Assignee: NEC Corporation, Minato-ku, Tokyo (JP)

(21) Appl. No.: 17/911,464

(22) PCT Filed: Mar. 30, 2020
(86) PCT No.: PCT/JP2020/014456

§ 371 Date: Sep. 14, 2022

(51) Int. Cl. G06F 21/32; G06Q 30/0283

(52) U.S. Cl. CPC G06F 21/32; G06Q 30/0283

(57) ABSTRACT

An information processing device includes a first authentication controlling unit that causes an authentication device to execute first facial authentication or facial registration of a first photographed image capturing a user at a first store, a presenting unit that presents recommendation information related to a second store to the user in response to a success of the first facial authentication or in response to the facial registration, a second authentication controlling unit that causes the authentication device to execute second facial authentication of a second photographed image capturing the user at the second store, and a calculating unit that calculates a fee that the second store is to pay for having the recommendation information presented to the user, based on a result of the second facial authentication and a history of the first facial authentication or the facial registration.

### TECHNICAL FIELD

The present invention relates to information processing devices, systems, methods, and non-transitory computer-readable media storing programs and relates, in particular, to an information processing device, a system, a method, and a non-transitory computer-readable medium storing a program each for calculating a fee for having information presented.

### BACKGROUND ART

Patent Literature 1 discloses a technique of providing bonus information based on position information of a user terminal in order to send a user in a predetermined store to another store. The system according to Patent Literature 1 determines a fee to be paid to this predetermined store for sending a customer if the provided bonus information is used.

### CITATION LIST

### Patent Literature

Patent Literature 1: Japanese Unexamined Patent Application Publication No. 2019-149098

### SUMMARY OF INVENTION

### Technical Problem

The system according to Patent Literature 1 is not capable of identifying a person to whom bonus information has been provided. Therefore, this system has shortcomings in that the effect of an advertisement cannot be measured sufficiently.

The present disclosure has been made to address such an issue and is directed to providing an information processing device, a system, a method, and a program for evaluating the effect of an advertisement appropriately.

### Solution to Problem

An information processing device according to the present disclosure includes: first authentication controlling means for causing an authentication device to execute first facial authentication or facial registration of a first photographed image capturing a user at a first store; presenting means for presenting recommendation information related to a second store to the user in response to a success of the first facial authentication or in response to the facial registration; second authentication controlling means for causing the authentication device to execute second facial authentication of a second photographed image capturing the user at the second store; and calculating means for calculating a fee that the second store is to pay for having the recommendation information presented to the user, based on a result of the second facial authentication and a history of the first facial authentication or the facial registration.

An information processing device according to the present disclosure includes: first authenticating means for executing first facial authentication or facial registration of a first photographed image capturing a user at a first store; presenting means for presenting recommendation information related to a second store to the user in response to a success of the first facial authentication or in response to the facial registration; second authenticating means for executing second facial authentication of a second photographed image capturing the user at the second store; and calculating means for calculating a fee that the second store is to pay for having the recommendation information presented to the user, based on a result of the second facial authentication and a history of the first facial authentication or the facial registration.

An information processing system according to the present disclosure includes: an authentication device including authenticating means configured to perform facial authentication; and an information processing device, wherein the information processing device is configured to cause the authentication device to execute first facial authentication or facial registration of a first photographed image capturing a user at a first store, present recommendation information related to a second store to the user in response to a success of the first facial authentication or in response to the facial registration, cause the authentication device to execute second facial authentication of a second photographed image capturing the user at the second store, and calculate a fee that the second store is to pay for having the recommendation information presented to the user, based on a result of the second facial authentication and a history of the first facial authentication or the facial registration.

An information processing method according to the present disclosure is to be executed by a computer and includes: causing an authentication device to execute first facial authentication or facial registration of a first photographed image capturing a user at a first store; presenting recommendation information related to a second store to the user in response to a success of the first facial authentication or in response to the facial registration; causing the authentication device to execute second facial authentication of a second photographed image capturing the user at the second store; and calculating a fee that the second store is to pay for having the recommendation information presented to the user, based on a result of the second facial authentication and a history of the first facial authentication or the facial registration.

An information processing method according to the present disclosure is to be executed by a computer and includes: executing first facial authentication or facial registration of a first photographed image capturing a user at a first store; presenting recommendation information related to a second store to the user in response to a success of the first facial authentication or in response to the facial registration; executing second facial authentication of a second photographed image capturing the user at the second store; and calculating a fee that the second store is to pay for having the recommendation information presented to the user, based on a result of the second facial authentication and a history of the first facial authentication or the facial registration.

An information processing program according to the present disclosure causes a computer to execute: a process of causing an authentication device to execute first facial authentication or facial registration of a first photographed image capturing a user at a first store; a process of presenting recommendation information related to a second store to the user in response to a success of the first facial authentication or in response to the facial registration; a process of causing the authentication device to execute second facial authentication of a second photographed image capturing the user at the second store; and a process of calculating a fee that the second store is to pay for having the recommendation information presented to the user, based on a result of the second facial authentication and a history of the first facial authentication or the facial registration.

An information processing program according to the present disclosure causes a computer to execute: a process of executing first facial authentication or facial registration of a first photographed image capturing a user at a first store; a process of presenting recommendation information related to a second store to the user in response to a success of the first facial authentication or in response to the facial registration; a process of executing second facial authentication of a second photographed image capturing the user at the second store; and a process of calculating a fee that the second store is to pay for having the recommendation information presented to the user, based on a result of the second facial authentication and a history of the first facial authentication or the facial registration.

### Advantageous Effects of Invention

The present disclosure can provide an information processing device, a system, a method, and a program for evaluating the effect of an advertisement appropriately.

### BRIEF DESCRIPTION OF DRAWINGS

FIG. 1 is a block diagram illustrating a configuration of an information processing device according to a first example embodiment.

FIG. 2 is a flowchart illustrating a flow of an information processing method according to the first example embodiment.

FIG. 3 is a block diagram illustrating a configuration of an information processing device according to a second example embodiment.

FIG. 4 is a block diagram illustrating a configuration of an information processing system according to a third example embodiment.

FIG. 5 is a block diagram illustrating a configuration of an authentication device according to the third example embodiment.

FIG. 6 is a flowchart illustrating a flow of a facial information registration process according to the third example embodiment.

FIG. 7 is a flowchart illustrating a flow of a facial authentication process according to the third example embodiment.

FIG. 8 is a block diagram illustrating a configuration of a facial authentication terminal according to the third example embodiment.

FIG. 9 is a block diagram illustrating a configuration of a user terminal according to the third example embodiment.

FIG. 10 is a block diagram illustrating a configuration of an information processing device according to the third example embodiment.

FIG. 11 is a sequence diagram illustrating an example of a flow of an information processing method according to the third example embodiment.

FIG. 12 is a sequence diagram illustrating an example of a flow of an information processing method according to the third example embodiment.

### EXAMPLE EMBODIMENT

Hereinafter, some example embodiments of the present disclosure will be described in detail with reference to the drawings. In the drawings, identical or corresponding elements are given identical reference characters, and duplicate description thereof will be omitted as necessary in order to make the description clearer.

### First Example Embodiment

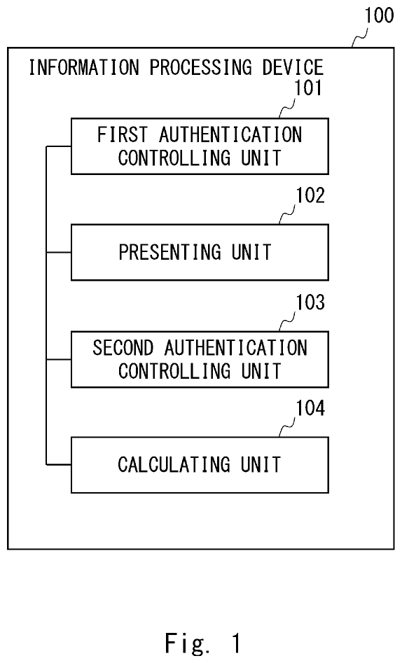

FIG. 1 is a block diagram illustrating a configuration of an information processing device 100 according to a first example embodiment. The information processing device 100 includes a first authentication controlling unit 101, a presenting unit 102, a second authentication controlling unit 103, and a calculating unit 104. The information processing device 100 is connected to a network 500 (not illustrated). The network 500 may be a wired network or a wireless network.

An authentication device 200 (not illustrated) is connected to the network 500. The authentication device 200 performs facial authentication by use of facial feature information extracted from a facial image. The authentication device 200 may register facial feature information to be used for facial authentication (may perform facial registration).

The first authentication controlling unit 101 causes the authentication device 200 to execute first facial authentication or facial registration of a first photographed image capturing a user at a first store. The presenting unit 102 presents recommendation information related to a second store to the user in response to the facial registration or the success of the first facial authentication. The presenting unit 102 may output the recommendation information to a display unit of a facial authentication terminal installed at the first store or to a user terminal owned by the user. The recommendation information may be bonus information to be applied to a settlement process at the second store or advertisement information introducing the second store. The recommendation information may be information that is based on an attribute (age, gender, etc.) of the user.

The second authentication controlling unit 103 causes the authentication device 200 to execute second facial authentication of a second photographed image capturing the user at the second store. The calculating unit 104 calculates a fee that the second store is to pay for having the recommendation information presented to the user, based on the result of the second facial authentication and a history of first facial authentication or facial registration. The history may be, for example, an authentication history recording the user ID (identifier) of the user authenticated successfully in the first facial authentication. Alternatively, the history may be a history of a settlement process or settlement processes performed in response to the success of first facial authentication. Herein, a fee to be paid for having recommendation information presented may be paid to the first store or to a business entity providing the information processing device 100.

For example, the calculating unit 104 calculates a fee based on whether the user ID of the user authenticated successfully in second facial authentication is included in the history. The calculating unit 104 may calculate a fee based on whether the user authenticated successfully in second facial authentication has been authenticated at a first store within a predetermined period.

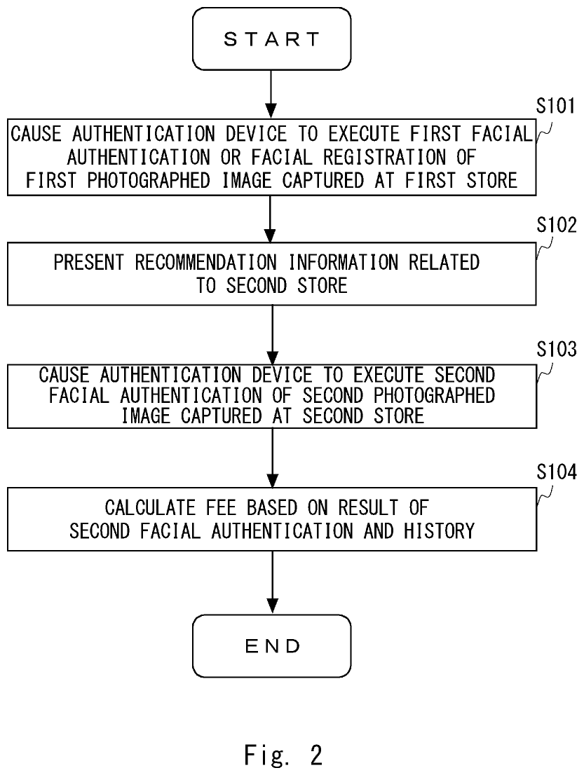

FIG. 2 is a flowchart illustrating a flow of an information processing method according to the first example embodiment. First, the first authentication controlling unit 101 causes the authentication device 200 to execute first facial authentication or facial registration of a first photographed image capturing a user at a first store (step S101). The first photographed image includes at least a facial region of the user. Next, the presenting unit 102 presents recommendation information related to a second store to the user in response to the facial registration or the success of the first facial authentication (step S102).

Next, the second authentication controlling unit 103 causes the authentication device 200 to perform second facial authentication of a second photographed image capturing the user at the second store (step S103). Lastly, the calculating unit 104 calculates a fee that the second store is to pay for having the recommendation information presented, based on the result of the second facial authentication and a history of the process at step S101 (step S104).

As described above, it has been impossible with conventional techniques to evaluate the effect of an advertisement appropriately. In contrast, the information processing device according to the present example embodiment can assure that the person presented with an advertisement has visited a given store through facial authentication, and thus the effect of the advertisement can be evaluated appropriately.

Herein, the information processing device 100 includes, as its components, a processor, a memory, and a storage device (none illustrated). The storage device stores a computer program that implements the processes of the information processing method according to the present example embodiment. The processor loads the computer program from the storage device onto the memory and executes the computer program. Thus, the processor implements the functions of the first authentication controlling unit 101, the presenting unit 102, the second authentication controlling unit 103, and the calculating unit 104.

Alternatively, the first authentication controlling unit 101, the presenting unit 102, the second authentication controlling unit 103, and the calculating unit 104 may each be implemented by a dedicated piece of hardware. A part or the whole of the constituent elements of each device may be implemented by, for example, general-purpose or dedicated circuitry, a processor, or a combination thereof. Such constituent elements may be formed by a single chip or by a plurality of chips connected via a bus. A part or the whole of the constituent elements of each device may be implemented by a combination of the above-described circuitry or the like and a program. For the processor, a central processing unit (CPU), a graphics processing unit (GPU), a field-programmable gate array (FPGA), or the like can be used.

In a case where a part or the whole of the constituent elements of the information processing device 100 is implemented by a plurality of information processing devices, circuitries, or the like, these information processing devices, circuitries, or the like may be disposed centrally or distributedly. For example, these information processing devices, circuitries, or the like may be implemented in a mode in which they are connected to each other via a communication network, as in, for example, a client server system or a cloud computing system.

The function of the information processing device 100 may be provided in a Software as a Service (SaaS) format.

### Second Example Embodiment

A second example embodiment is a modification example of the first example embodiment described above. The information processing device 100 according to the first example embodiment performs individual authentication by the external authentication device 200. In contrast, an information processing device 100 according to the second example embodiment performs individual authentication within the device. The information processing device 100, for example, includes a storage unit that stores facial feature information of a plurality of persons and performs facial authentication by use of the facial feature information of the plurality of persons.

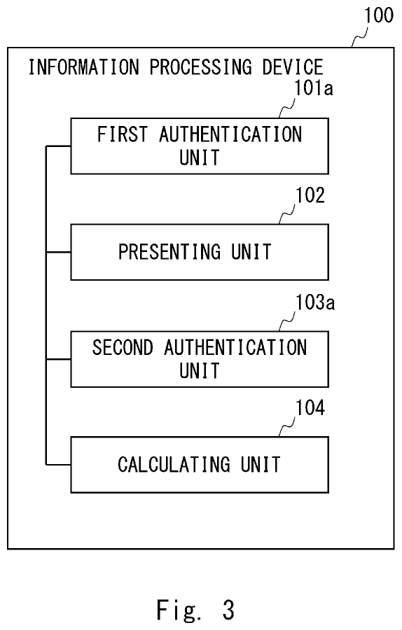

FIG. 3 is a block diagram illustrating a configuration of the information processing device 100 according to the second example embodiment. The information processing device 100 includes a first authenticating unit 101a, a presenting unit 102, a second authenticating unit 103a, and a calculating unit 104. The functions of the presenting unit 102 and the calculating unit 104 are similar to those according to the first example embodiment, and thus description thereof will be omitted.

The first authenticating unit 101a according to the second example embodiment performs first facial authentication or facial registration of a first photographed image of a user captured at a first store. The second authenticating unit 103a according to the second example embodiment performs second facial authentication of a second photographed image capturing the user at a second store.

A flow of an information processing method according to the second example embodiment is similar to the flow illustrated in FIG. 2. However, at step S101, the first authenticating unit 101a performs first facial authentication or facial registration of a first photographed image. Then, at step S103, the second authenticating unit 103a performs second facial authentication of a second photographed image.

In this manner, the second example embodiment too can provide advantageous effects similar to those provided by the first example embodiment described above.

### Third Example Embodiment

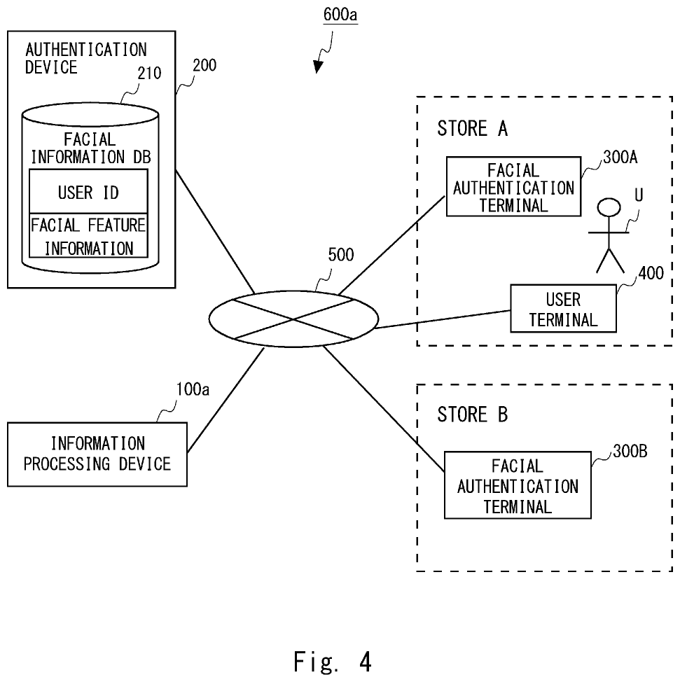

A third example embodiment is a specific example of the first example embodiment described above. According to the third example embodiment, a user undergoes first facial authentication at a first store and second facial authentication at a second store. FIG. 4 is a block diagram illustrating a configuration of an information processing system 600a according to the third example embodiment. The information processing system 600a includes an information processing device 100a, an authentication device 200, a facial authentication terminal 300A, a facial authentication terminal 300B, and a user terminal 400. The information processing device 100a, the authentication device 200, the facial authentication terminal 300A, the facial authentication terminal 300B, and the user terminal 400 are connected to each other via a network 500. According to the third example embodiment, facial feature information of a plurality of users are registered in advance in the authentication device 200.

The information processing device 100a presents recommendation information to a user who has undergone facial authentication at a store A. Then, the information processing device 100a calculates a fee to be paid for having the recommendation information presented, based on a history of facial authentication at the store A and the result of facial authentication at a store B. In other words, the store A is a first store, and the store B is a second store. Herein, there may be a plurality of first stores. For example, the information processing system 600a may include a facial authentication terminal 300C that performs first facial authentication at a store C.

Herein, a fee may be paid to the first store or to a business entity that operates the information processing system 600a or the information processing device 100a. A history of facial authentication may be a history of a settlement process or settlement processes performed in response to the success of first facial authentication. Each function of the information processing device 100a will be described later.

The authentication device 200 includes a facial information DB 210. The facial information DB 210 stores mapping between a user ID and facial feature information of this user. The facial information DB 210 is also referred to as a storage unit. The authentication device 200, in response to receiving a facial authentication request from the outside, compares a facial image or facial feature information included in the received request against the facial feature information of the user and returns the result of the comparison to the requestor.

A facial authentication terminal 300 is a terminal device that performs facial authentication at each store. The facial authentication terminal 300 is, for example, digital signage. A facial authentication terminal 300 installed at the store A is referred to as a facial authentication terminal 300A. A facial authentication terminal 300 installed at the store B is referred to as a facial authentication terminal 300B. The facial authentication terminal 300A displays, on a display unit, recommendation information related to the store B. Herein, the information processing system 600a may display the recommendation information related to the store B on the user terminal 400.

Furthermore, the facial authentication terminal 300A may perform a settlement process in response to the success of facial authentication at the store A. The facial authentication terminal 300B too may perform a settlement process in response to the success of facial authentication at the store B. In other words, the facial authentication terminals 300A and 300B may each be a settlement terminal.

The user terminal 400 is a terminal owned by a user U. The user terminal 400 is, for example but not limited to, a mobile phone terminal, a smartphone, a tablet terminal, or a personal computer (PC) equipped with or connected to a camera. The user terminal 400 transmits, to the authentication device 200, a registration image to be used for facial authentication of the user U and makes a facial information registration request. Herein, the user terminal 400 may transmit facial feature information extracted from the registration image to the authentication device 200 and make a facial information registration request. The user terminal 400 may receive recommendation information related to the store B from the information processing device 100a and display the recommendation information.

Specifically, the user terminal 400 is a device that registers facial feature information extracted from a facial image of the user U into the facial information DB 210 before facial authentication, described later, is performed. Herein, the user U may register facial feature information by use of a device other than the user terminal 400. The user U may register facial feature information by use of, for example, a facial authentication terminal equipped with a function of making a facial information registration request described above.

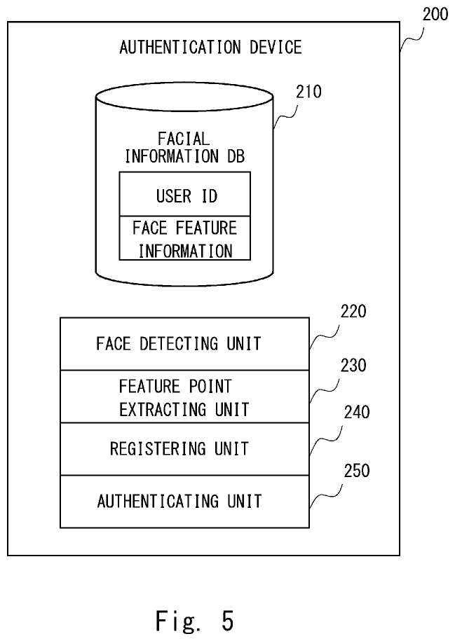

Next, some functions of the authentication device 200 will be described in detail. FIG. 5 is a block diagram illustrating a configuration of the authentication device 200. The authentication device 200 includes the facial information DB 210 described earlier, a face detecting unit 220, a feature point extracting unit 230, a registering unit 240, and an authenticating unit 250.

The face detecting unit 220 detects a facial region included in a registration image for registering facial information and outputs the detected facial region to the feature point extracting unit 230. The feature point extracting unit 230 extracts feature points from the facial region detected by the face detecting unit 220 and outputs facial feature information to the registering unit 240. In this example, the facial feature information is a set of extracted feature points. The feature point extracting unit 230 also extracts feature points included in a facial image received from the information processing device 100a and outputs facial feature information to the authenticating unit 250.

The registering unit 240 issues a new user ID when registering facial feature information. The registering unit 240 registers mapping between the issued user ID and the facial feature information extracted from the registration image into the facial information DB 210. The authenticating unit 250 compares the facial feature information extracted from the facial image against the facial feature information in the facial information DB 210. The authenticating unit 250 returns, to the information processing device 100a, the presence or absence of a match between the two pieces of facial feature information. The presence or absence of a match between the two pieces of facial feature information corresponds to the success or failure of the authentication.

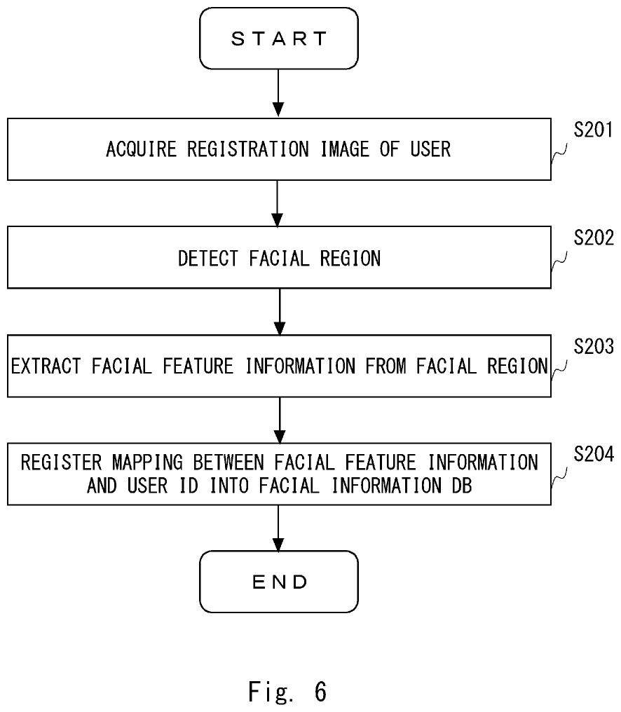

FIG. 6 is a flowchart illustrating a flow of a facial information registration process performed by the authentication device 200. First, the authentication device 200 acquires a registration image included in a facial information registration request (step S201). For example, the authentication device 200 receives the facial information registration request from the user terminal 400 or the like via the network 500. Next, the face detecting unit 220 detects a facial region included in the registration image (step S202). Next, the feature point extracting unit 230 extracts feature points from the facial region detected at step S202 and outputs facial feature information to the registering unit 240 (step S203). Lastly, the registering unit 240 issues a user ID and registers mapping between this user ID and the facial feature information into the facial information DB 210 (step S204). Herein, the authentication device 200 may receive the facial feature information from the user terminal 400 or the like and register mapping between the facial feature information and the user ID into the facial information DB 210.

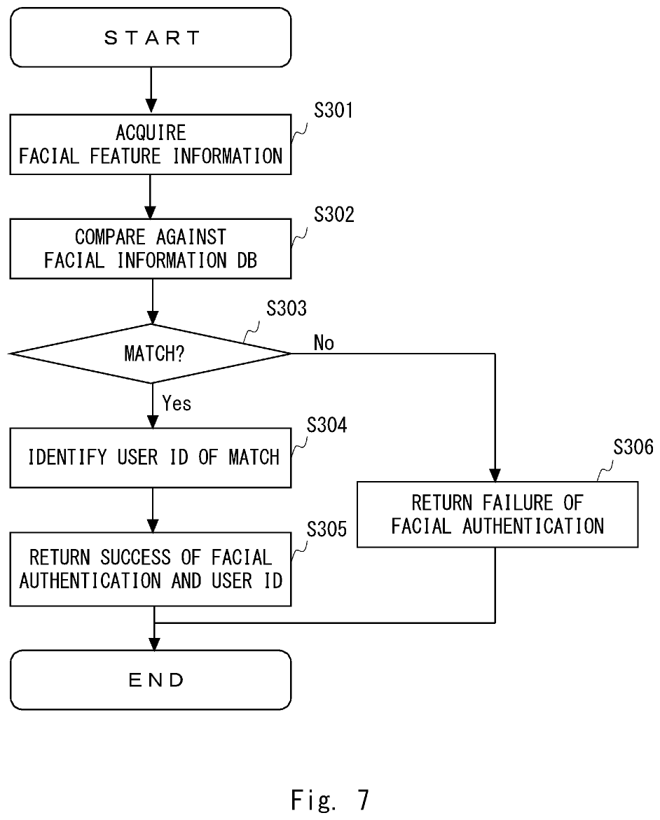

FIG. 7 is a flowchart illustrating a flow of a facial authentication process performed by the authentication device 200. First, the feature point extracting unit 230 acquires facial feature information from a facial image received from the information processing device 100a (step S301). For example, the authentication device 200 receives a facial image from the information processing device 100a and extracts facial feature information as in steps S201 to S203. Alternatively, the authentication device 200 may receive facial feature information from the information processing device 100a. Next, the authenticating unit 250 compares the acquired facial feature information against the facial information DB 210 (step S302). If the facial feature information has a match (Yes at step S303), the authenticating unit 250 identifies the user ID of the user that the facial feature information has matched with (step S304) and returns the success of the facial authentication and the identified user ID to the information processing device 100a (step S305). If the facial feature information has no match (No at step S303), the authenticating unit 250 returns the failure of the facial authentication to the information processing device 100a (step S306).

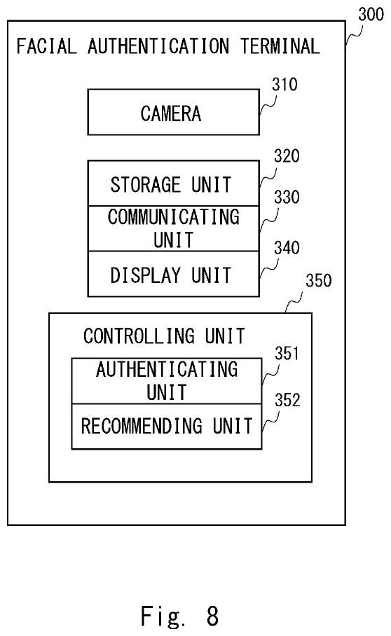

Next, a facial authentication terminal 300 will be described in detail. The facial authentication terminal 300 includes, as its hardware components, a photographing device such as a camera, a display device, and a computer. FIG. 8 is a block diagram illustrating a configuration of the facial authentication terminal 300.

The facial authentication terminal 300 includes a camera 310 as mentioned above, a storage unit 320, a communicating unit 330, a display unit 340, and a controlling unit 350. The storage unit 320 is a storage device that stores a program for implementing each function of the facial authentication terminal 300. The communicating unit 330 is a communication interface with the network 500. The display unit 340 is the display device mentioned above. The controlling unit 350 controls hardware components of the facial authentication terminal 300. The controlling unit 350 includes an authenticating unit 351 and a recommending unit 352.

The authenticating unit 351 photographs a user to be subjected to facial authentication by controlling the camera 310, transmits the captured photographed image to the information processing device 100a, and causes the information processing device 100a to perform facial authentication. The photographed image is an image that includes at least a facial image of the user. The authenticating unit 351 of the facial authentication terminal 300 may have a function of, after transmitting the photographed image of the user, performing a settlement in accordance with a settlement instruction from the information processing device 100a.

The recommending unit 352 displays recommendation information in accordance with an instruction from the information processing device 100a. The recommending unit 352 of the facial authentication terminal 300A displays, for example, recommendation information related to the store B. The recommendation information may be information on a coupon to be applied to a settlement process at the store B or may simply be an advertisement introducing the store B. Herein, the facial authentication terminal 300B does not have to have the function of displaying recommendation information.

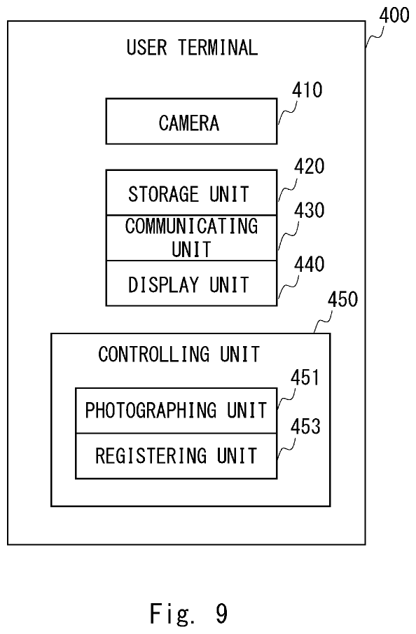

Next, the user terminal 400 will be described. The user terminal 400 is, for example, a mobile phone terminal owned by the user. FIG. 9 is a block diagram illustrating a configuration of the user terminal 400. The user terminal 400 includes a camera 410, a storage unit 420, a communicating unit 430, and a display unit 440. The user terminal 400 further includes a controlling unit 450 that controls the aforementioned hardware components. The controlling unit 450 includes a photographing unit 451 and a registering unit 453.

The user terminal 400 has a function of making a facial information registration request. A flow of a facial information registration process will be described below. The photographing unit 451 first controls the camera 410 to obtain a registration image of the user. Next, the registering unit 453 transmits a facial information registration request including the registration image to the authentication device 200 via the network 500. The registering unit 453 may receive the registered user ID as a registration result. Herein, the registering unit 453 may transmit, to the authentication device 200, a facial information registration request including facial feature information extracted from the registration image.

The user terminal 400 may further include a recommending unit 452 (not illustrated). As with the recommending unit 352 of the facial authentication terminal 300, the recommending unit 452 receives recommendation information from the information processing device 100a and displays the recommendation information on the display unit 440. Herein, in a case where the facial authentication terminal 300A displays recommendation information, the user terminal 400 does not have to include the recommending unit 452.

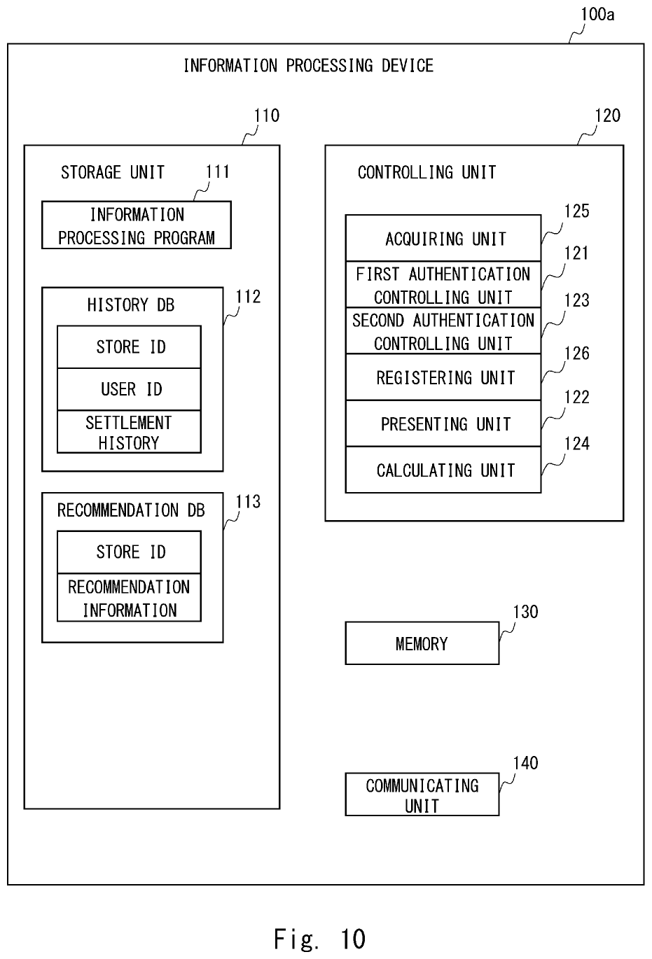

Next, some functions of the information processing device 100a will be described with reference to FIG. 10. The information processing device 100a is an information processing device that calculates a fee that the store B pays and is, for example, a server device implemented by a computer. As illustrated in FIG. 10, the information processing device 100a includes a storage unit 110, a controlling unit 120, a memory 130, and a communicating unit 140.

The storage unit 110 is a storage device, such as a hard disk or a flash memory. The controlling unit 120 controls each function of the information processing device 100a. The memory 130 is a volatile storage device, such as a random-access memory (RAM), and is a storage area for temporarily holding information while the controlling unit 120 operates. The communicating unit 140 is a communication interface with the network 500.

The storage unit 110 stores at least an information processing program 111, a history DB 112, and a recommendation DB 113. The information processing program 111 is a computer program equipped with the information processing method according to the present example embodiment.

The history DB 112 has a history of facial authentication of a user recorded therein. In this example, the history DB 112 stores mapping between a store ID and the user ID of a user who has visited the store. A history of facial authentication may be a history of a settlement process or settlement processes performed in response to first facial authentication. In this case, the history DB 112 stores mapping between the store ID, the user ID, and the settlement history. A calculating unit 124, described later, calculates a fee that the store B is to pay, based on the history DB 112.

The recommendation DB 113 stores an association between recommendation information and a store ID. The recommendation DB 113 is a database that a presenting unit 122, described later, refers to when outputting recommendation information. The recommendation information to be associated with the store ID of the store A may be, for example, an advertisement related to the store B or a coupon to be applied to a settlement at the store B.

The controlling unit 120 loads the information processing program 111 from the storage unit 110 onto the memory 130 and executes the information processing program 111. Thus, the controlling unit 120 implements the functions of an acquiring unit 125, a first authentication controlling unit 121, a second authentication controlling unit 123, a registering unit 126, a presenting unit 122, and a calculating unit 124. Herein, the first authentication controlling unit 121 is an example of the first authentication controlling unit 101, the second authentication controlling unit 123 is an example of the second authentication controlling unit 103, the presenting unit 122 is an example of the presenting unit 102, and the calculating unit 124 is an example of the calculating unit 104.

The acquiring unit 125 acquires, from each store, a photographed image captured by a facial authentication terminal 300. The first authentication controlling unit 121 causes the authentication device 200 to execute facial authentication of a first photographed image that the acquiring unit 125 has acquired from the facial authentication terminal 300A. The second authentication controlling unit 123 causes the authentication device 200 to execute facial authentication of a second photographed image that the acquiring unit 125 has acquired from the facial authentication terminal 300B. The registering unit 126 registers, into the history DB 112, the user ID of a user authenticated successfully in facial authentication at the store A. The registering unit 126 may register an association between a settlement history and a user ID into the history DB 112.

The presenting unit 122 outputs recommendation information to the facial authentication terminal 300A in response to the success of facial authentication at the store A. The presenting unit 122 may output the recommendation information to the facial authentication terminal 300A after receiving the result of facial authentication from the authentication device 200. In a case where the facial authentication terminal 300A is a settlement terminal, the presenting unit 122 may output the recommendation information after receiving a settlement history from the facial authentication terminal 300A. The presenting unit 122 may display, for example, a message stating “10% OFF BOXED TISSUES AT STORE B!” on the facial authentication terminal 300A.

The presenting unit 122 may display the recommendation information on the user terminal 400, instead of the facial authentication terminal 300A. In this example, the presenting unit 122 may output the recommendation information to the user terminal 400 based on the user ID included in the settlement history received from the facial authentication terminal 300 or included in the result of authentication received from the authentication device 200. An assumption in this example is that the user is logged in to the user terminal 400 with his or her user ID.

The calculating unit 124 calculates a fee to be paid for having recommendation information presented, based on the result of second facial authentication and the history DB 112. For example, if a user authenticated successfully in facial authentication at the store B is included in a history of facial authentication at the store A, the calculating unit 124 calculates a fee to be paid, based on the monetary amount settled in a settlement process of this user at the store B. An example of a flow of a process in which the calculating unit 124 calculates a fee will be described below. First, the calculating unit 124 acquires the user ID of an authenticated user from the second authentication controlling unit 123. Next, the calculating unit 124 determines whether this user is included in the history DB 112 and thus confirms whether recommendation information has been presented to this user. Lastly, the calculating unit 124 calculates a fee that the store B is to pay, based on the confirmation result.

The calculating unit 124 may calculate the fee with the monetary amount settled at the store B taken into consideration. For example, the calculating unit 124 may calculate the fee based on the monetary amount settled at the store B. Moreover, the calculating unit 124 may set the fee to be paid when the person presented with recommendation information at the store A has undergone a settlement process at the store B higher than a fee to be paid when this person has undergone only facial authentication at the store B.

Moreover, the calculating unit 124 may calculate the fee based on the number of users authenticated successfully in second facial authentication and included in a history of first facial authentication. In the following description, the store A and the store C are each a first store, and the store B is a second store. As one example, the number of users authenticated successfully in facial authentication at the store B and included in a history of facial authentication at the store A is 100. Meanwhile, the number of users authenticated successfully in facial authentication at the store B and included in a history of facial authentication at the store C is 50. In such a case, the calculating unit 124 calculates the fee such that the fee to be paid to the store A is higher than the fee to be paid to the store C.

Moreover, the calculating unit 124 may calculate the fee based on the time during which first facial authentication has been performed. For example, the calculating unit 124 may calculate the fee based on the current time and the time at which first facial authentication has been performed or may calculate the fee based on both the time at which first facial authentication has been performed and the time at which second facial authentication has been performed.

In this case, the calculating unit 124 calculates the fee in accordance with the length of time from when recommendation information has been presented to when second facial authentication is performed. The time at which facial authentication has been performed may record the time in units of seconds or may record the date. Moreover, the time at which facial authentication has been performed may be the time at which a settlement process has been performed in response to the success of facial authentication.

An advertisement is considered to be more effective as the length of time from when recommendation information, such as a coupon, is presented to when a settlement process is performed at the second store is shorter and considered to be less effective as this length of time is longer. In this case, the calculating unit 124 can calculate a lower fee as this length of time is longer and calculate a higher fee as this length of time is shorter.

Furthermore, the calculating unit 124 may calculate the fee based on whether merchandise included in recommendation information presented at the first store has been purchased. If the registering unit 126 registers a merchandise ID of an item of merchandise included in recommendation information into the history DB 112, the calculating unit 124 can calculate the fee for the purchase of a recommended item of merchandise based on the history DB 112.

For example, the presenting unit 122 presents recommendation information indicating apples as advertised merchandise to the user U at the first store. In this case, the calculating unit 124 calculates the fee based on whether the user U has purchased an apple at the second store. The calculating unit 124 may set the fee to be paid when the user U purchases an apple at the second store higher than the fee to be paid when the user U purchases merchandise other than apples.

Herein, the calculating unit 124 may calculate, for a single settlement process at the second store, a fee that is based on a plurality of reasons. For example, for a single settlement process, the calculating unit 124 may calculate a fee that is based on the fact that facial authentication or facial registration has been performed at the first store and a fee that is based on the fact that a predetermined amount or more has been settled at the second store.

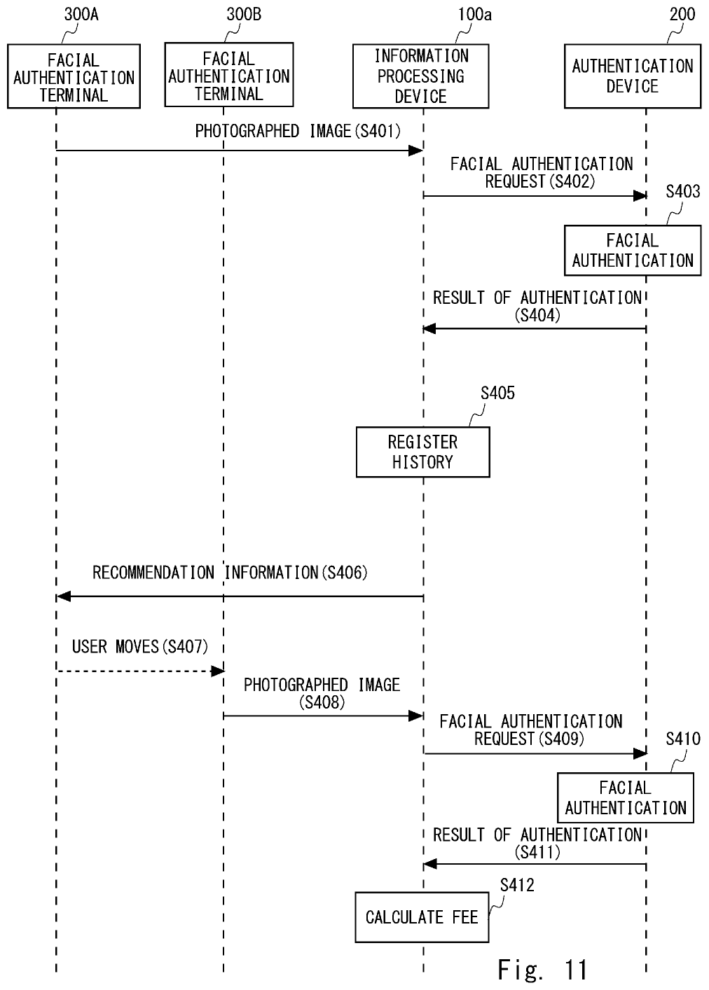

FIG. 11 is a sequence diagram illustrating an example of an operation of the information processing system 600a according to the present example embodiment. First, the acquiring unit 125 of the information processing device 100a acquires, from the facial authentication terminal 300A, a photographed image of a user U who is to undergo facial authentication at the store A (step S401). Next, the first authentication controlling unit 121 of the information processing device 100a transmits a facial authentication request to the authentication device 200 and causes the authentication device 200 to perform facial authentication (step S402). Next, the authentication device 200 performs facial authentication (step S403) and transmits, to the information processing device 100a, the success of the authentication and the user ID of the authenticated user U as the result of the authentication (step S404). The registering unit 126 of the information processing device 100a registers the result of the authentication into the history DB 112 (step S405).

Herein, the facial authentication terminal 300A may perform a settlement process after step S404. In this case, the facial authentication terminal 300A performs a settlement process in accordance with a settlement instruction from the information processing device 100a. Then, the registering unit 126 of the information processing device 100a acquires a settlement history from the facial authentication terminal 300A and registers the settlement history into the history DB 112.

Next, the presenting unit 122 of the information processing device 100a displays recommendation information related to the store B on the display unit 340 of the facial authentication terminal 300A (step S406). The recommendation information may be an advertisement of the store B or a notification concerning a discount at the store B. The presenting unit 122 of the information processing device 100a may also output the recommendation information to the user terminal 400. Herein, the process at step S405 may be performed after the process at step S406.

The user U presented with the recommendation information of the store B moves from the store A to the store B at step S407. The acquiring unit 125 of the information processing device 100a acquires, from the facial authentication terminal 300B, a photographed image of the user who is to undergo facial authentication at the store B (step S408). Next, the second authentication controlling unit 123 of the information processing device 100a causes the authentication device 200 to perform facial authentication (step S409). Next, the authentication device 200 performs second facial authentication (step S410) and transmits, to the second authentication controlling unit 123 of the information processing device 100a, the success of the authentication and the user ID of the user U as the result of the authentication (step S411).

Next, the calculating unit 124 calculates a fee based on the history DB 112 and the user ID of the user U subjected to the second facial authentication. In this example, the calculating unit 124 can determine that the recommendation information has been presented to the user subjected to the second facial authentication, if the user ID acquired at step S411 is included in the history DB 112. Then, the calculating unit 124 may calculate the fee in accordance with the number of persons confirmed to have the recommendation information presented at the first store and confirmed to have visited the second store. In this example, whether the recommendation information has been presented at the first store can be determined based on a history of first facial authentication. Whether a user has visited the second store can be determined based on the result of second facial authentication.

The calculating unit 124 may display the calculated fee on a display unit of a management terminal managing the first store or the second store. In this example, the calculating unit 124 may further display a reason for the calculated fee. For example, the calculating unit 124 displays, as a reason for the calculated fee, that the fee is incurred since the person who has undergone facial authentication or facial registration at the store A has visited the store B on the display unit of the management terminal.

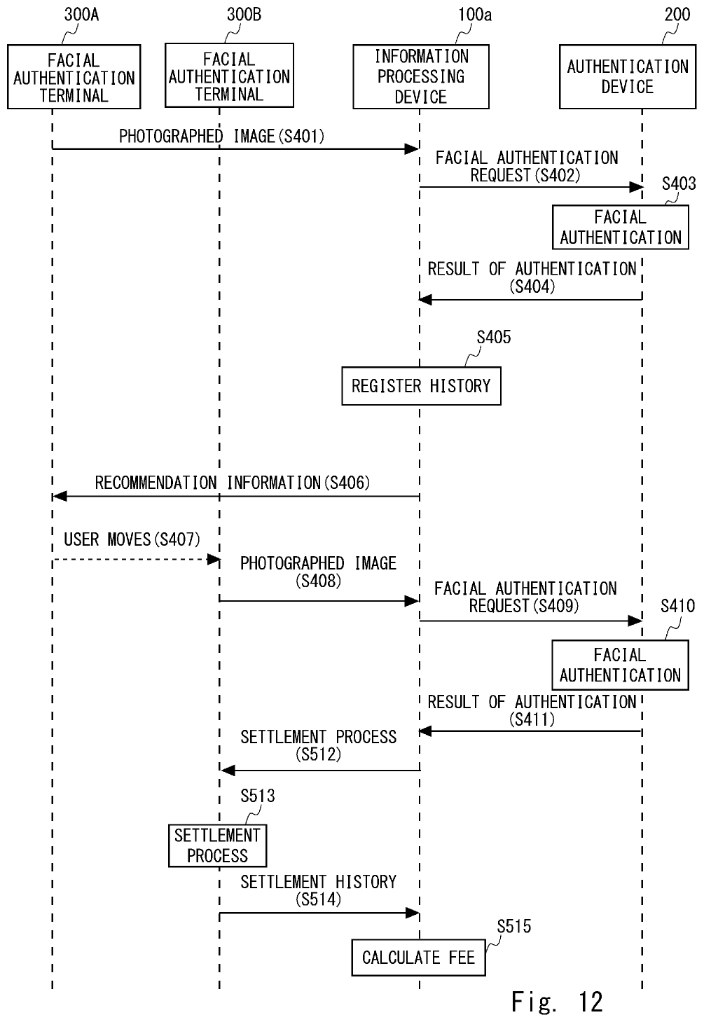

Moreover, the calculating unit 124 of the information processing device 100a may calculate the fee in accordance with the monetary amount settled in a settlement process performed in response to the success of second facial authentication. FIG. 12 is a sequence diagram illustrating an example of a flow performed when the information processing system 600a performs a settlement process in response to the success of second facial authentication. Step S401 to step S411 are similar to those of FIG. 11, and thus description thereof will be omitted.

After the success of the second facial authentication at step S411, the information processing device 100a issues a settlement instruction to the facial authentication terminal 300B (step S512). Next, the facial authentication terminal 300B performs a settlement process in accordance with the settlement instruction (step S513) and transmits a settlement history to the information processing device 100a (step S514). The calculating unit 124 checks whether the user for whom the settlement process has been performed is registered in the history DB 112 and can calculate a fee based on the settlement history (step S515).

Moreover, the calculating unit 124 may calculate the fee based on the total amount settled for users authenticated successfully in second facial authentication and included in a history of first facial authentication. In the following description, the store A and the store C are each a first store, and the store B is a second store. As one example, the total amount settled at the store B for users authenticated successfully in facial authentication at the store B and included in a history of facial authentication at the store A is 10,000,000 yen. Meanwhile, the total amount settled at the store B for users authenticated successfully in facial authentication at the store B and included in a history of facial authentication at the store C is 5,000,000 yen. In such a case, the calculating unit 124 calculates the fee to be paid to the store A higher than the fee to be paid to the store C.

Herein, the calculating unit 124 of the information processing device 100a may calculate the fee in accordance with the monetary amount settled in a settlement process performed in response to first facial authentication. In this case, the store B pays a higher fee as a person who has settled a higher monetary amount at the store A is sent to the store B.

The information processing device 100a according to the present example embodiment presents recommendation information in response to the success of facial authentication at a first store. Therefore, the information processing device 100a can measure the effect of an advertisement brought about by the recommendation information appropriately and calculate an appropriate fee based on the result of second facial authentication and a history of first facial authentication.

### Fourth Example Embodiment

The information processing device 100a according to the third example embodiment causes facial authentication to be performed of a photographed image capturing a user at a first store. Meanwhile, an information processing device 100a according to a fourth example embodiment causes facial registration to be performed of a photographed image capturing a user at a first store. An information processing system 600a according to the fourth example embodiment has a configuration similar to the configuration illustrated in FIG. 4. A facial authentication terminal 300A is, for example, a digital signage installed at a store A.

The information processing device 100a according to the fourth example embodiment has a configuration similar to the configuration illustrated in FIG. 10. However, a first authentication controlling unit 121 causes an authentication device 200 to execute facial registration of a photographed image capturing a user and acquired from the facial authentication terminal 300A. Then, the first authentication controlling unit 121 receives the user ID of the registered user as the result of facial registration from the authentication device 200.

A registering unit 126 registers the user ID received from the authentication device 200 into a history DB 112. A presenting unit 122 displays recommendation information on a digital signage 900 in response to the facial registration of the user. The contents to be displayed are, for example but not limited to, “10% OFF AT STORE B.” The calculating unit 124 calculates a fee that the store B is to pay, based on the result of facial authentication at the store B and a history of facial registration at the store A.

An operation of the information processing system 600a according to the fourth example embodiment is similar to the one illustrated in FIG. 11. However, the registering unit 126 registers the user ID of the user subjected to facial registration and received at step S404 into the history DB 112 (step S405). Then, the calculating unit 124 calculates the fee based on the result of second facial authentication and a history of facial registration at the store A (step S412).

The method in which the fee is calculated is similar to any of the methods according to the third example embodiment. The fee may be calculated with the monetary amount settled at the store B taken into consideration, as illustrated in FIG. 12.

In this manner, even in a case where facial registration, not facial authentication, is performed at a first store, advantageous effects similar to those provided by the third example embodiment described above can be provided. The information processing device 100a can determine whether a person who has undergone facial registration at a first store has visited a second store and can thus calculate a fee in which the effect of an advertisement is evaluated appropriately.

Herein, an individual may be identified by use of a technology other than the facial authentication technology. For example, an individual may be identified through a QR code (registered trademark) mapped to each user.

The foregoing example embodiments have been described as hardware configurations, but these are not limiting examples. The present disclosure can also be implemented via desired processes by causing a CPU to execute a computer program.

In the foregoing examples, a program can be stored and provided to a computer by use of various types of non-transitory computer-readable media. Non-transitory computer-readable media include various types of tangible storage media. Examples of such non-transitory computer-readable media include a magnetic recording medium (e.g., flexible disk, magnetic tape, hard-disk drive), a magneto-optical recording medium (e.g., magneto-optical disk), a CD-ROM (read-only memory), a CD-R, a CD-R/W, a DVD (digital versatile disc), and a semiconductor memory (e.g., mask ROM, PROM (programmable ROM), EPROM (erasable PROM), flash ROM, RAM (random-access memory)). Meanwhile, a program may be supplied to a computer by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

It is to be noted that the present disclosure is not limited to the foregoing example embodiments, and modifications can be made, as appropriate, within the scope that does not depart from the technical spirit. The present disclosure may also be implemented by combining the example embodiments, as appropriate.

Thus far, the invention of the present application has been described with reference to some example embodiments (and examples). The invention of the present application, however, is not limited to the foregoing example embodiments (and examples). Various modifications that a person skilled in the art can appreciate can be made to the configurations and the details of the invention of the present application within the scope of the invention of the present application.

A part or the whole of the foregoing example embodiments can also be expressed as in the following supplementary notes, which are not limiting.

### (Supplementary Note 1)

An information processing device comprising:

first authentication controlling means for causing an authentication device to execute first facial authentication or facial registration of a first photographed image capturing a user at a first store;

presenting means for presenting recommendation information related to a second store to the user in response to a success of the first facial authentication or in response to the facial registration;

second authentication controlling means for causing the authentication device to execute second facial authentication of a second photographed image capturing the user at the second store; and

calculating means for calculating a fee that the second store is to pay for having the recommendation information presented to the user, based on a result of the second facial authentication and a history of the first facial authentication or the facial registration.

### (Supplementary Note 2)

The information processing device according to Supplementary Note 1, wherein the calculating means calculates the fee based further on a monetary amount settled in a settlement process performed in response to a success of the second facial authentication.

### (Supplementary Note 3)

The information processing device according to Supplementary Note 2, wherein the calculating means calculates the fee so that the fee becomes higher as the monetary amount settled in the settlement process performed in response to the success of the second facial authentication becomes higher.

### (Supplementary Note 4)

The information processing device according to Supplementary Note 1, wherein the calculating means calculates the fee based on the number of users authenticated successfully in the second facial authentication and included in the history.

### (Supplementary Note 5)

The information processing device according to Supplementary Note 2 or 3, wherein the calculating means calculates the fee based on a total amount settled in the settlement process of users authenticated successfully in the second facial authentication and included in the history.

### (Supplementary Note 6)

The information processing device according to any one of Supplementary Notes 1 to 5, wherein the history is a settlement history of a settlement process performed in response to the success of the first facial authentication.

### (Supplementary Note 7)

The information processing device according to any one of Supplementary Notes 1 to 6, wherein the calculating means calculates the fee based on a period of time during which the first facial authentication or the facial registration has been performed.

### (Supplementary Note 8)

An information processing device comprising:

first authenticating means for executing first facial authentication or facial registration of a first photographed image capturing a user at a first store;

presenting means for presenting recommendation information related to a second store to the user in response to a success of the first facial authentication or in response to the facial registration;

second authenticating means for executing second facial authentication of a second photographed image capturing the user at the second store; and

calculating means for calculating a fee that the second store is to pay for having the recommendation information presented to the user, based on a result of the second facial authentication and a history of the first facial authentication or the facial registration.

### (Supplementary Note 9)

The information processing device according to Supplementary Note 8, wherein the calculating means calculates the fee based further on a monetary amount settled in a settlement process performed in response to a success of the second facial authentication.

### (Supplementary Note 10)

An information processing system comprising:

an authentication device including authenticating means configured to perform facial authentication; and

an information processing device,

wherein the information processing device is configured to
cause the authentication device to execute first facial authentication or facial registration of a first photographed image capturing a user at a first store,
present recommendation information related to a second store to the user in response to a success of the first facial authentication or in response to the facial registration,
cause the authentication device to execute second facial authentication of a second photographed image capturing the user at the second store, and
calculate a fee that the second store is to pay for having the recommendation information presented to the user, based on a result of the second facial authentication and a history of the first facial authentication or the facial registration.

### (Supplementary Note 11)

The information processing system according to Supplementary Note 10, wherein the information processing device is configured to calculate the fee based further on a monetary amount settled in a settlement process performed in response to a success of the second facial authentication.

### (Supplementary Note 12)

An information processing method to be executed by a computer, the information processing method comprising:

causing an authentication device to execute first facial authentication or facial registration of a first photographed image capturing a user at a first store;

presenting recommendation information related to a second store to the user in response to a success of the first facial authentication or in response to the facial registration;

causing the authentication device to execute second facial authentication of a second photographed image capturing the user at the second store; and

calculating a fee that the second store is to pay for having the recommendation information presented to the user, based on a result of the second facial authentication and a history of the first facial authentication or the facial registration.

### (Supplementary Note 13)

An information processing method to be executed by a computer, the information processing method comprising:

executing first facial authentication or facial registration of a first photographed image capturing a user at a first store;

presenting recommendation information related to a second store to the user in response to a success of the first facial authentication or in response to the facial registration;

executing second facial authentication of a second photographed image capturing the user at the second store; and

calculating a fee that the second store is to pay for having the recommendation information presented to the user, based on a result of the second facial authentication and a history of the first facial authentication or the facial registration.

### (Supplementary Note 14)

A non-transitory computer-readable medium storing an information processing program that causes a computer to execute:

a process of causing an authentication device to execute first facial authentication or facial registration of a first photographed image capturing a user at a first store;

a process of presenting recommendation information related to a second store to the user in response to a success of the first facial authentication or in response to the facial registration;

a process of causing the authentication device to execute second facial authentication of a second photographed image capturing the user at the second store; and

a process of calculating a fee that the second store is to pay for having the recommendation information presented to the user, based on a result of the second facial authentication and a history of the first facial authentication or the facial registration.

### (Supplementary Note 15)

A non-transitory computer-readable medium storing an information processing program that causes a computer to execute:

a process of executing first facial authentication or facial registration of a first photographed image capturing a user at a first store;

a process of presenting recommendation information related to a second store to the user in response to a success of the first facial authentication or in response to the facial registration;

a process of executing second facial authentication of a second photographed image capturing the user at the second store; and

a process of calculating a fee that the second store is to pay for having the recommendation information presented to the user, based on a result of the second facial authentication and a history of the first facial authentication or the facial registration.

### REFERENCE SIGNS LIST

100, 100a INFORMATION PROCESSING DEVICE
101, 121 FIRST AUTHENTICATION CONTROLLING UNIT
101a FIRST AUTHENTICATING UNIT
102, 122 PRESENTING UNIT
103, 123 SECOND AUTHENTICATION CONTROLLING UNIT
103a SECOND AUTHENTICATING UNIT
104, 124 CALCULATING UNIT
125 ACQUIRING UNIT
126 REGISTERING UNIT
110 STORAGE UNIT
111 INFORMATION PROCESSING PROGRAM
112 HISTORY DB
113 RECOMMENDATION DB
130 MEMORY
140 COMMUNICATING UNIT
200 AUTHENTICATION DEVICE
210 FACIAL INFORMATION DB
220 FACE DETECTING UNIT
230 FEATURE POINT EXTRACTING UNIT
240 REGISTERING UNIT
250 AUTHENTICATING UNIT
300, 300A, 300B, 300C FACIAL AUTHENTICATION TERMINAL
310 CAMERA
320 STORAGE UNIT
330 COMMUNICATING UNIT
340 DISPLAY UNIT
350 CONTROLLING UNIT
351 AUTHENTICATING UNIT
352 RECOMMENDING UNIT
400 USER TERMINAL
410 CAMERA
420 STORAGE UNIT
430 COMMUNICATING UNIT
440 DISPLAY UNIT
450 CONTROLLING UNIT
451 PHOTOGRAPHING UNIT
453 REGISTERING UNIT
500 NETWORK
600, 600a INFORMATION PROCESSING SYSTEM

What is claimed is:

1. An information processing device comprising:
at least one memory storing instructions, and
at least one processor configured to execute the instructions to:
cause an authentication device to execute first facial authentication or facial registration of a first photographed image capturing a user at a first store;
present recommendation information related to a second store to the user in response to a success of the first facial authentication or in response to the facial registration;
cause the authentication device to execute second facial authentication of a second photographed image capturing the user at the second store; and
calculate a fee that the second store is to pay for having the recommendation information presented to the user, based on a result of the second facial authentication and a history of the first facial authentication or the facial registration.

2. The information processing device according to claim 1, wherein the at least one processor is configured to execute the instructions to:
calculate the fee based further on a monetary amount settled in a settlement process performed in response to a success of the second facial authentication.

3. The information processing device according to claim 2, wherein the at least one processor is configured to execute the instructions to:
calculate the fee so that the fee becomes higher as the monetary amount settled in the settlement process performed in response to the success of the second facial authentication becomes higher.

4. The information processing device according to claim 1, wherein the at least one processor is configured to execute the instructions to:
calculate the fee based on the number of users authenticated successfully in the second facial authentication and included in the history.

5. The information processing device according to claim 2, wherein the at least one processor is configured to execute the instructions to:
calculate the fee based on a total amount settled in the settlement process of users authenticated successfully in the second facial authentication and included in the history.

6. The information processing device according to claim 1, wherein the history is a settlement history of a settlement process performed in response to the success of the first facial authentication.

7. The information processing device according to claim 1, wherein the at least one processor is configured to execute the instructions to:
calculate the fee based on a period of time during which the first facial authentication or the facial registration has been performed.

8. An information processing device comprising:
at least one memory storing instructions, and
at least one processor configured to execute the instructions to:
execute first facial authentication or facial registration of a first photographed image capturing a user at a first store;
present recommendation information related to a second store to the user in response to a success of the first facial authentication or in response to the facial registration;
execute second facial authentication of a second photographed image capturing the user at the second store; and
calculate a fee that the second store is to pay for having the recommendation information presented to the user, based on a result of the second facial authentication and a history of the first facial authentication or the facial registration.

9. The information processing device according to claim 8, wherein the at least one processor is configured to execute the instructions to:
calculate the fee based further on a monetary amount settled in a settlement process performed in response to a success of the second facial authentication.

10. An information processing system comprising:
an authentication device including authenticating means configured to perform facial authentication; and
an information processing device,
wherein the information processing device is configured to
cause the authentication device to execute first facial authentication or facial registration of a first photographed image capturing a user at a first store,
present recommendation information related to a second store to the user in response to a success of the first facial authentication or in response to the facial registration,
cause the authentication device to execute second facial authentication of a second photographed image capturing the user at the second store, and
calculate a fee that the second store is to pay for having the recommendation information presented to the user, based on a result of the second facial authentication and a history of the first facial authentication or the facial registration.

11. The information processing system according to claim 10, wherein the information processing device is configured to calculate the fee based further on a monetary amount settled in a settlement process performed in response to a success of the second facial authentication.

12. An information processing method to be executed by a computer, the information processing method comprising:
causing an authentication device to execute first facial authentication or facial registration of a first photographed image capturing a user at a first store;
presenting recommendation information related to a second store to the user in response to a success of the first facial authentication or in response to the facial registration;
causing the authentication device to execute second facial authentication of a second photographed image capturing the user at the second store; and
calculating a fee that the second store is to pay for having the recommendation information presented to the user, based on a result of the second facial authentication and a history of the first facial authentication or the facial registration.

13. An information processing method to be executed by a computer, the information processing method comprising:
executing first facial authentication or facial registration of a first photographed image capturing a user at a first store;
presenting recommendation information related to a second store to the user in response to a success of the first facial authentication or in response to the facial registration;
executing second facial authentication of a second photographed image capturing the user at the second store; and
calculating a fee that the second store is to pay for having the recommendation information presented to the user, based on a result of the second facial authentication and a history of the first facial authentication or the facial registration.

14. A non-transitory computer-readable medium storing an information processing program that causes a computer to execute:
a process of causing an authentication device to execute first facial authentication or facial registration of a first photographed image capturing a user at a first store;
a process of presenting recommendation information related to a second store to the user in response to a success of the first facial authentication or in response to the facial registration;
a process of causing the authentication device to execute second facial authentication of a second photographed image capturing the user at the second store; and
a process of calculating a fee that the second store is to pay for having the recommendation information presented to the user, based on a result of the second facial authentication and a history of the first facial authentication or the facial registration.

15. A non-transitory computer-readable medium storing an information processing program that causes a computer to execute:
a process of executing first facial authentication or facial registration of a first photographed image capturing a user at a first store;
a process of presenting recommendation information related to a second store to the user in response to a success of the first facial authentication or in response to the facial registration;
a process of executing second facial authentication of a second photographed image capturing the user at the second store; and
a process of calculating a fee that the second store is to pay for having the recommendation information presented to the user, based on a result of the second facial authentication and a history of the first facial authentication or the facial registration.
